(19) United States
(12) Patent Application Publication
(10) Pub. No.: US 2013/0122243 A1
(43) Pub. Date: May 16, 2013

(54) RESILIENCE CUSHION MAT

(71) Applicant: Lois Griffin, Bethel, NC (US)

(72) Inventor: Lois Griffin, Bethel, NC (US)

(21) Appl. No.: 13/294,506

(22) Filed: Nov. 11, 2011

(51) Int. Cl. B32B 3/00; B29C 45/14; B32B 3/12

(52) U.S. Cl. 428/116; 428/173; 264/279

(57) ABSTRACT

We provide a cushioned mat with anti-fatigue qualities. In one embodiment the mat includes a PVC base layer reinforced by a polyester layer and having an indentation that holds a woven PVC fabric insert. Glue is applied to the insert and/or the base layer, which is then heat-pressed to complete and enhance the bond. The resulting product has enhanced comfort and durability properties

### BACKGROUND OF THE INVENTION

1. Field of the Invention

Embodiments of the invention relate to mats, temporary floor coverings, and anti-fatigue surfaces.

2. Description of the Related Art

Many occupations or activities require that a person engaged in that occupation or activity stand for a significant period of time. Such standing may be tiring or, when done continuously, even harmful. In other cases a person may have a condition that makes standing for even short periods of time either hazardous or uncomfortable. In other situations there is no inherent danger or discomfort involved in standing for an activity, but a person who is standing might still appreciate if the comfort level of the standing surface were increased.

A number of solutions have been proposed for making a standing environment more comfortable. Typically these solutions involve cushioned floor mats that may be made from rubber, foam, or another material. Unfortunately, as has been reported previously, for example in U.S. Pat. No. 5,876,825, to Daley (incorporated by reference herein), many solutions made from rubber, foam, or other materials are unsightly or do not provide a comfortable enough surface. Additional solutions, such as that provided in the Daley patent cited above, may be unsatisfactory because they are insufficient durable for use over long periods of time, or for use in inhospitable environments. Furthermore, they may require complicated or expensive methods of construction.

### BRIEF SUMMARY OF THE INVENTION

Embodiments of the invention provide a resilient mat having a base layer with at least one indentation and at least one insert secured in the indentation by a combination of an adhesive and heat pressing.

In a preferred embodiment the base layer is PVC, a lower insert is PVC in a honeycomb configuration, and the top-most insert is woven PVC. In other embodiments at least one insert is PVC, polyester, nylon, cotton, or polypropylene. The insert may be woven, knit, or non-woven fabric. The base layer may be textured on the top and/or bottom, or may include adhesives or other additives as desired. Typically the base layer is beveled.

Other embodiments provide a method for making a resilient mat, including the steps of (a) pouring a base layer having at least one edge into a mold; (b) creating an indentation in the base layer; and (c) placing at least one insert in the indentation; and securing said at least one insert in said indentation with at least one of an adhesive and heat pressing.

### DETAILED DESCRIPTION OF THE FIGURES

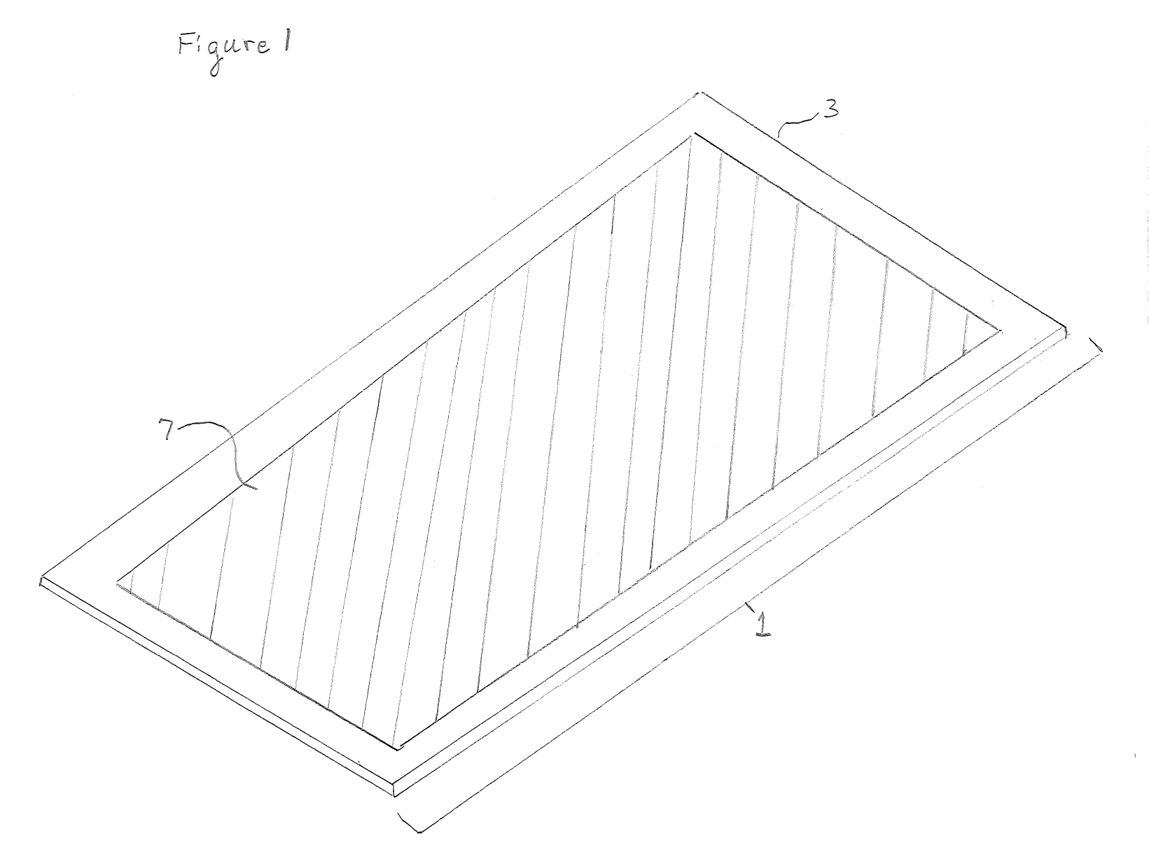

FIG. 1 illustrates a perspective view of a mat of an embodiment of the invention.

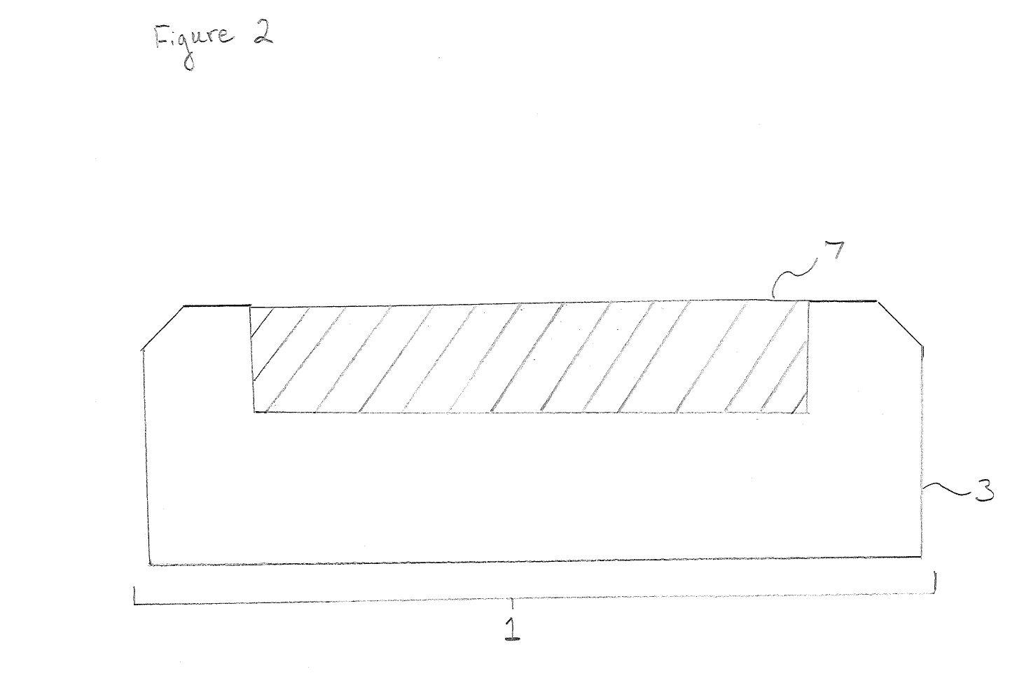

FIG. 2 illustrates a cutaway view of a mat according to an embodiment of the invention.

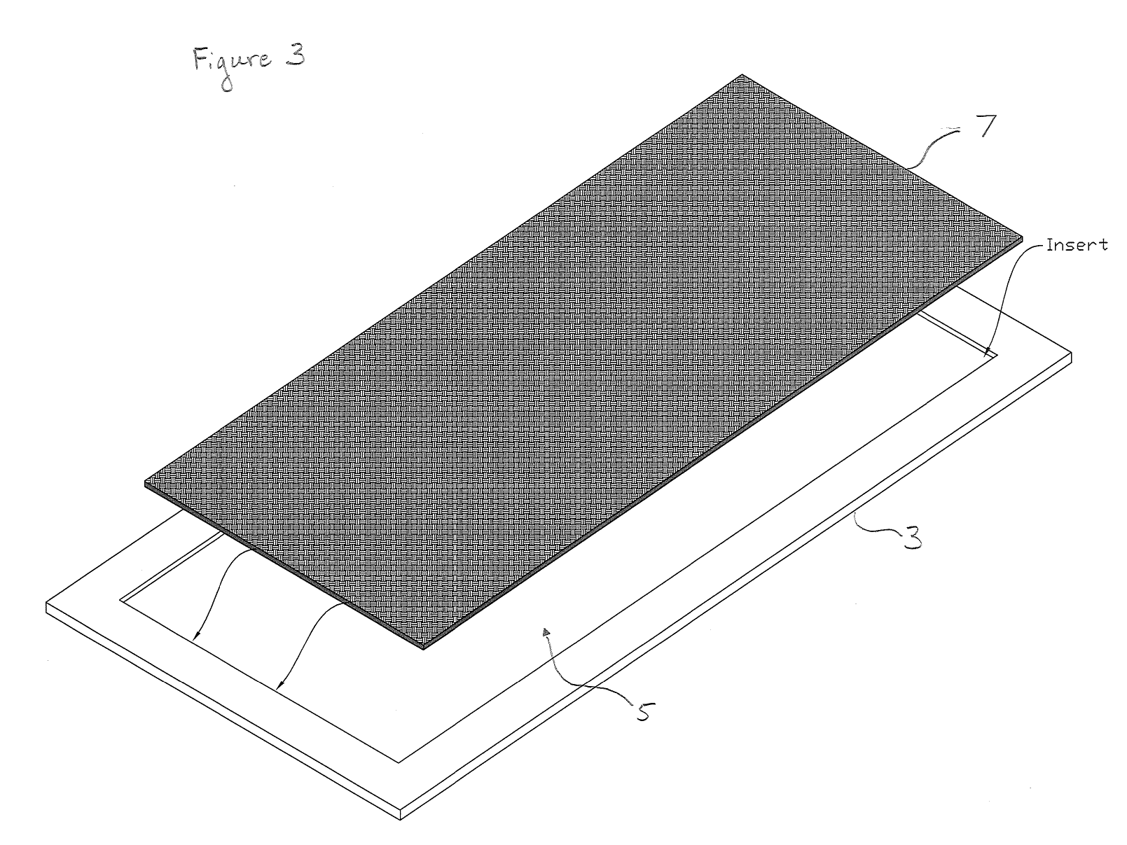

FIG. 3 illustrates an exploded view of a mat according to an embodiment of the invention.

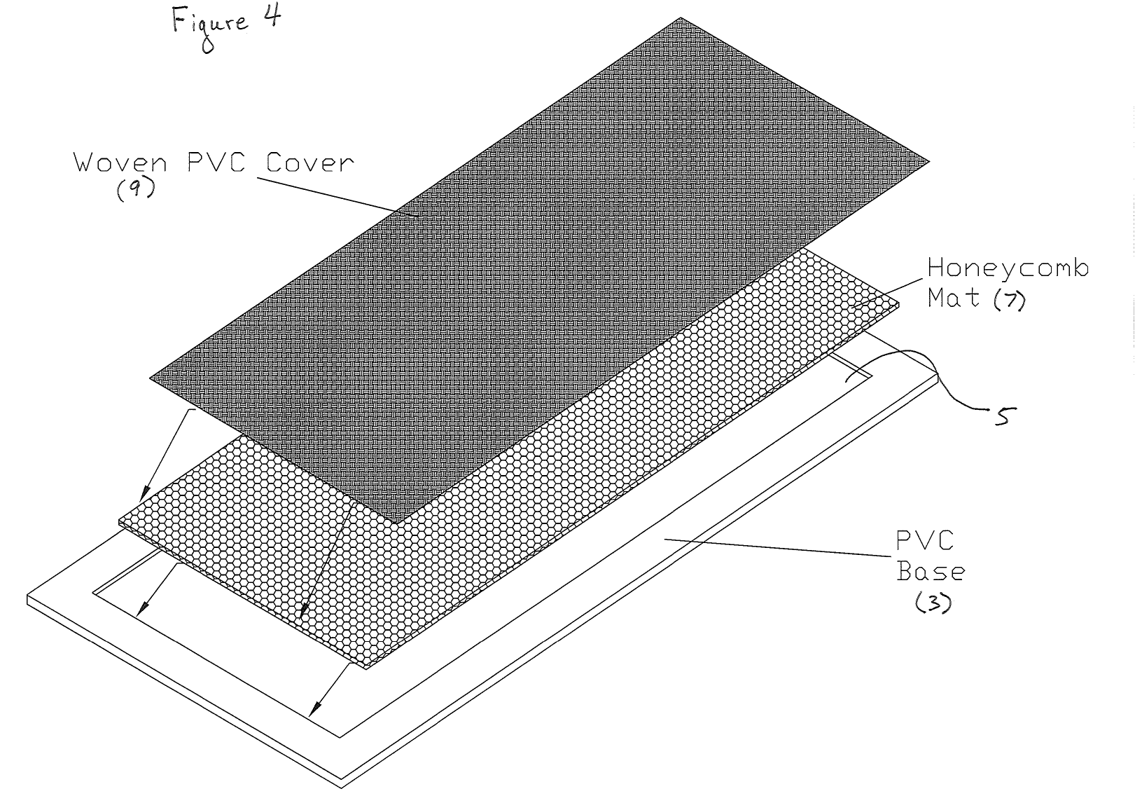

FIG. 4 shows a honeycomb insert of one embodiment of the invention.

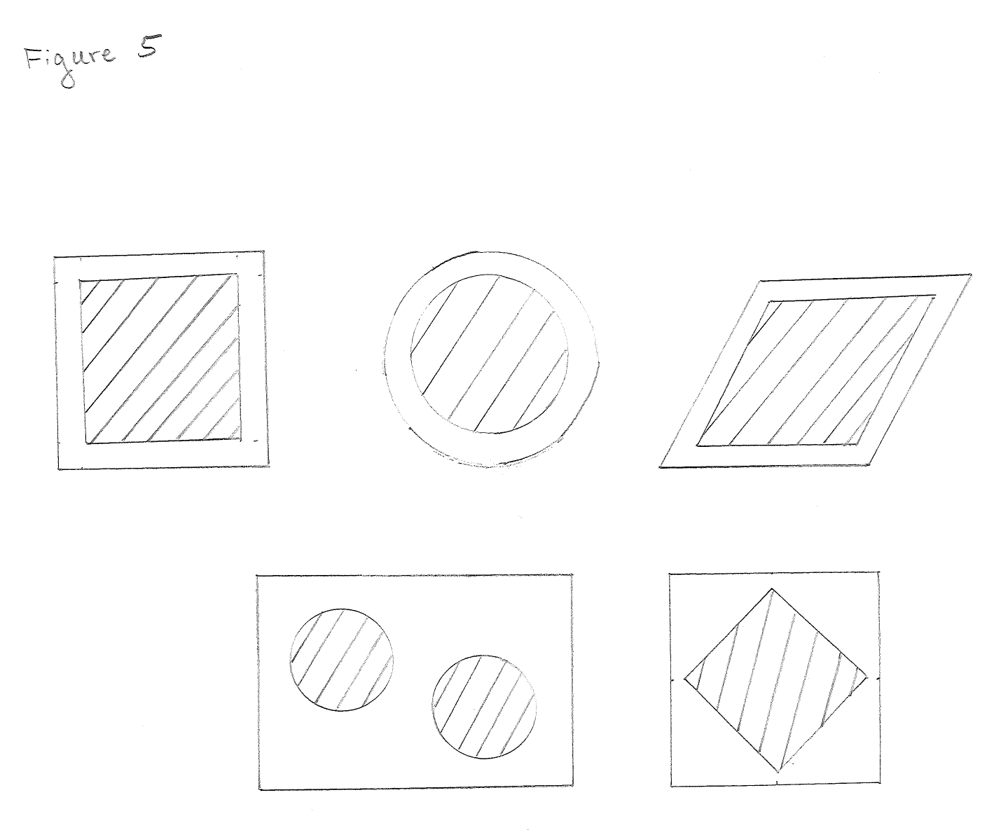

FIG. 5 illustrates to views of alternative shapes of varying embodiments of the invention.

### DETAILED DESCRIPTION OF THE INVENTION

Embodiments of the invention will now be described more fully with reference to the accompanying drawings. Like numbers refer to like elements throughout the figures.

Embodiments of the invention provide a reinforced cushion mat including at least one insert in a recess of the mat. Typically these embodiments provide a user with a superior cushioning effect resulting in enhanced comfort. Mats will tend to stay in a desired location due to their weight and, optionally, due to a patterned lower surface. They may have beveled edges. They provide advantages including color-fastness, and easy cleaning. They may provide desirable color accents using a decorative uppermost insert.

One embodiment of the invention is shown in FIG. 1. FIG. 1 shows a mat 1 including a base layer 3 having an indentation 5 (not shown in FIG. 1) into which insert 7 has been placed.

FIG. 2 shows a side cutaway view of an embodiment of the invention. As above, mat 1 includes base layer 3, indentation 5, and an insert 7. These aspects of an exemplary mat are also shown in FIG. 3, which displays the mat in an exploded view.

In a preferred embodiment the mat is made of polyvinyl chloride (PVC). Typically the PVC is phthalate-free PVC. In many embodiments the PVC is free of heavy metals. Although throughout this description various process descriptions will refer to PVC, one of skill in the art will recognize when this may be applied to additional polymers. In other embodiments the mat may be made of another durable polymer, including but not limited to ethylvinyl acetate, polyethylene vinyl acetate, and polyolefin. The color of the mat may be varied. For a PVC mat the color is varied by addition of pigment during the PVC mixing process.

Mats are constructed by first creating a mold large enough to accommodate the largest mat that is desired as an end-product, recognizing that using a mold significantly larger than the intended final mat size could result in significant waste of materials and is therefore not preferred (though still contemplated). PVC is poured into the mold in a flowable state.

In some embodiments the bottom of the mat is flat and unornamented. In other embodiments the bottom of the mat includes a textured design that is created by the mold. In still further embodiments the bottom of the mat includes suction cups or other adhesives. This embodiment may be particularly suitable for use in a shower or bath, or in other situations where a non-slip character is preferred.

While the mat is still in the mold, an indentation is made on the top of the PVC. This indentation is used to contain at least one insert. In another embodiment of the invention more than one indentation is made to hold more than one insert. In a further embodiment multiple inserts are included in a single indentation. They may be adjacent or layered. In a preferred embodiment the insert has a honeycomb configuration.

Inserts used in embodiments of the invention may take many forms. In a preferred embodiment the insert is a woven PVC fabric that is cut to a size that will make a tight fit with the sides of the indentation, and with a height that is approximately the same as the height of the non-indented portion of the mat. The edges of the woven PVC fabric are heat sealed to prevent unraveling of the weave. Inserts may vary in style and color and need not be PVC. Inserts may be made from, for example, polyester, polypropylene, cotton, nylon, or other fibers. Fabrics that may be used as inserts include but are not limited to woven fabric, knit fabric, and non-woven fabric. Although in preferred embodiment inserts have a shape similar to that of the overall mat, that is not required. Thickness of the insert(s) may vary depending on the desired height of the mat and depth of the indentation. Typically an insert has a thickness between 6-15 mm; preferred embodiments have a thickness of 6 mm, 8 mm, 12 mm, or 15 mm. The insert may be higher than the top of the non-indented portion of the mat, flush with the top of the non-indented portion of the mat, or even below

In some embodiments multiple inserts may be placed in the indentation, one on top of another. This could allow use of a transparent layer on tope of the insert, or creation of a novel visual effect. In a preferred embodiment the insert is a 100% polyester “honeycomb” fabric. One example of this honeycomb fabric is shown in the exploded view of a mat shown in FIG. 4. This fabric has an outer netting of polyester on the top and bottom of the insert, with polyester coils between these layers. Use of hexagonal coils may give them a “honeycomb” appearance. Although not wishing to be bound by theory, it is believe that these coils help distribute weight and dissipate force to make the mat more comfortable.

The mat of FIG. 4 also includes a cover 9 over the insert. In this embodiment the cover is woven PVC, though those of skill in the art will recognize that other covers may be used. The cover may be retained, for example, through adhesive applied to the cover, the insert, or both.

After the insert is prepared, an adhesive is applied to the mat, the insert, or both. The adhesive may be glue, epoxy, or any other suitable adhesive. The insert is placed in the indentation on the top of the mat. The mat is then covered in paper. The paper covering prevents or at least minimizes discoloration or other damage to the mat during subsequent operations. The paper-covered mat is placed in a heated press, which improves the glue-to-fabric bond. Optionally the press finishes the mat by beveling the edges of the mat. A decorative surface pattern may also be applied during the press.

Finished products have many shapes and uses. The most common embodiment of the invention is a mat with dimensions that vary from 18 inches long by 30 inches wide (for a relatively small rectangular mat) to 40 inches long by 70 inches wide (for a relatively large rectangular mat). The height of the finished mat may be, for example, but is not limited to between 6 mm and 15 mm. Of course, one skilled in the art will recognize that molds and presses are not limited to rectangular configurations, and that other shapes are contemplated. For instance, mats may be circular, oval, or polygonal, and may be any of a variety of sizes. Various shapes of mats and inserts are shown in FIG. 5. Mats may be used, for example, in kitchens, grocery stores, convenience stores, on factory floors, on floors of homes, or in showers.

Of course, those of skill in the art will appreciate that although various embodiments of the invention have been described herein, a number of variations and modifications are possible.

We claim:

1. A resilient mat, comprising:
a base layer having a top, a bottom, and at least one side, wherein the top of said base layer comprises at least one indentation; and
at least one insert, said at least one insert secured in said indentation by at least one of heat pressing and adhesive.

2. The resilient mat of claim 1, wherein said base layer is made from a material selected from the group consisting of polyvinyl chloride (PVC), ethylvinyl acetate, polyethylene vinyl acetate, and polyolefin.

3. The resilient mat of claim 1, wherein at least one insert is a honeycomb patterned PVC insert.

4. The resilient mat of claim 1, wherein said at least one insert is made from a material selected from the group consisting of PVC, polyester, polypropylene, cotton, and nylon.

5. The resilient mat of claim 4, wherein said material is a fabric that is woven, knit, or non-woven.

6. The resilient mat of claim 1, wherein said adhesive is selected from the group consisting of glue and epoxy.

7. The resilient mat of claim 1, wherein the top of the base layer comprises surface ornamentation.

8. The resilient mat of claim 1, wherein the at least one base layer side is beveled.

9. The resilient mat of claim 1, further comprising a cover layer adhered to the insert opposite the base layer.

10. The resilient mat of claim 1, wherein the base layer bottom is adhesive.

11. The resilient mat of claim 1, wherein the base layer bottom comprises at least one suction cup.

12. The resilient mat of claim 1, wherein the base layer is PVC and the at least one insert is woven PVC.

13. A method for making a resilient mat, comprising:
(a) pouring a portion of a base layer having at least one edge into a mold;
(b) creating at least one indentation in said base layer;
(c) placing at least one insert in said indentation; and
(d) securing said at least one insert in said indentation with at least one of an adhesive and heat pressing.

14. The method of claim 13, wherein said base layer is made from a material selected from the group consisting of polyvinyl chloride (PVC), ethylvinyl acetate, polyethylene vinyl acetate, and polyolefin.

15. The method of claim 13, wherein said at least one insert is a honeycomb PVC insert.

16. The method of claim 13, wherein said insert is made from a material selected from the group consisting of PVC, polyester, polypropylene, cotton, and nylon.

17. The method of claim 13, comprising applying surface ornamentation to said base layer.

18. The method of claim 13, comprising beveling the at least one edge of the base layer.

19. The method of claim 13, comprising cutting and heat-sealing said insert prior to placing the insert in the indentation.

20. The method of claim 13, wherein the base layer is PVC and an outermost insert is woven PVC.
